(19) United States
(12) Patent Application Publication
(10) Pub. No.: US 2014/0230312 A1
(43) Pub. Date: Aug. 21, 2014

(54) SNAP TRAP

(71) Applicants: Gabriel Le Laidier, St. Gallen (CH); Silvin Jancic, Villmergen (CH); Dennis Walstad, Elburn, IL (US)

(72) Inventors: Gabriel Le Laidier, St. Gallen (CH); Silvin Jancic, Villmergen (CH); Dennis Walstad, Elburn, IL (US)

(73) Assignee: SWISSINNO SOLUTIONS AG, St. Gallen (CH)

(21) Appl. No.: 14/342,091

(22) PCT Filed: Sep. 2, 2011
(86) PCT No.: PCT/EP2011/065217

§ 371 Date: Feb. 28, 2014

(51) Int. Cl. A01M 23/30

(52) U.S. Cl. CPC A01M 23/30
USPC 43/82; 43/77; 43/81

(57) ABSTRACT

The disclosure relates to a snap trap for small animals such as mice or rats, comprising a striking device which can be brought into a striking position and a standby position. The snap trap comprises a housing with a base and with an elongate inner compartment which is open at both longitudinal ends, at one longitudinal end of which an inlet opening leading to an, in particular tunnel-shaped, inlet section of the housing is arranged and at the other longitudinal end of which the striking device is arranged in a striking region of the housing. The disclosure is distinguished by the fact that the striking device is designed for at least partially closing an end opening of the inner compartment in the striking region of the housing and in particular completely closes the opening when the striking device is in the striking position.

The invention relates to a snap trap for small animals, such as mice or rats, according to the preamble of claim 1.

A variety of embodiments of snap traps have been known, and have been in use, for some time now. These traps, however, are usually comparatively bulky, difficult to handle and expensive to produce. Not least, such traps often also pose an injury-related and infection-related risk since the striking mechanism is often freely accessible and can be triggered, for example, also by a user, children at play or pets. Moreover, such traps do not usually have any transporting container, in which case a person carrying the trap may be bitten, contaminated or exposed to other hazards by an animal, which may possibly just be injured.

Tunnel-form traps, in which the striking mechanism is accommodated in a rectilinear, tunnel-like interior, are therefore known. A rectilinear tunnel here has the advantage that it can be negotiated by a small animal more easily, for example, angled or curved passages. The tunnel-like housing here forms, in addition, an effective transporting means, in which the animal is secured by the striking mechanism without the person carrying the trap being exposed to injury or contamination or some other kind of unfavorable contact with the animal.

A generically comparable snap trap is described, for example, in GB 2 332 356. This snap trap comprises the tunnel-like housing in which a striking mechanism is arranged. The striking mechanism comprises a spring-tensioned wire bracket, which can be triggered via a treading platform arranged in the tunnel. The wire bracket has actuating elements which project outward out of the housing and by means of which the trap can be brought out of striking position into a standby position from the outside by a user. The trap here additionally comprises a closure mechanism for the entry opening, in which case the animal cannot leave the trap. For the purpose of removing an animal arrested in the trap, it is necessary to open a cover of the housing. There is nevertheless a risk here of a user being injured, or contaminated, by an animal which is still alive. Even if the animal were already dead, the user does not remain completely isolated from the animal's body. Moreover, the striking mechanism is difficult to tension and has a comparatively intricate design.

It is therefore an object of the present invention to avoid the disadvantages in the prior art and to create, in particular, a snap trap which prevents contact with an animal arrested in the snap trap. In addition, the intention is for the snap trap to be robust and straightforward to handle and to pose no risk of injury to people or pets. The snap trap, in addition, is intended to have a straightforward design and to be easy to clean.

These objects are achieved by a snap trap having the features of claim 1. Claim 1 relates to a snap trap for small animals, such as mice or rats, having a striking device, which can be brought into a striking position and a standby position. The snap trap comprises a housing with a floor and an elongate interior, which is open at the two longitudinal ends and has an entry opening to an, in particular tunnel-like, entry region of the housing arranged at its one longitudinal end and has the striking device arranged at its other longitudinal end, in a striking region of the housing. The striking device comprises a striking lever and a triggering lever, wherein the striking lever can be pre-tensioned counter to the spring force of a striking-spring element as it transfers from the striking position into the standby position, and the striking lever can be arrested in the standby position such that it can be released directly or indirectly by the triggering lever. The triggering lever is arranged such that the arresting of the striking lever can be released via the triggering lever by a small animal being present in the interior. The invention is distinguished in that the striking device is designed for at least partially closing an end-side opening of the interior in the striking region of the housing, and in particular it completely closes the opening when the striking device is in the striking position.

A floor of the housing refers here, and hereinbelow, to a wall region of the housing, or of the interior, which, in the ready-for-operation state, is arranged on a standing surface, or in the vicinity of a standing surface, on which the snap trap is set down. In the ready-for-operation state, the longitudinal axis of the housing is oriented largely parallel to the standing surface.

According to the invention, the striking device, at least in the striking position, forms a closure which at least partially closes, or closes off, the end-side opening of the interior at that longitudinal end of the housing which is remote from the entry opening, i.e. in the striking region. The closure or terminating means here need not be free of gaps, but should ensure that there is no contact between a user or a pet and an animal, or animal's body, arrested in the snap trap. The situation where a user or a pet can trigger the trap from the outside should likewise be prevented. The striking device is preferably designed such that the interior is also at least partially closed off at the end in standby position. In this case, there is no significant risk of a user or a pet triggering the trap from the outside as a result of undesired manipulation. It is particularly preferably possible for the striking device also to be designed such that the end-side opening is completely closed both in the striking position and in the standby position.

Since components of the striking device form a closure, these parts may also be provided on the trap such that they are accessible directly from the outside. It is therefore possible for parts of the striking device which do not constitute any injury-related risk and are provided, for example, for a user to manipulate the device to be formed directly, without any additional design measures being required, on closure components of the striking device and to be accessible from the outside. For example, actuating elements can be provided on the outside, directly on a component of the striking device, in order for it to be possible to bring the snap trap straightforwardly into the standby position, i.e. to tension the same.

In contrast, regions or elements of the striking device which constitute an injury-related risk can be arranged in the interior, in which case they are not accessible from the outside at least in the striking position. For example a striking element which may be provided on the striking lever to deliver the fatal blow and also the striking-spring element may be arranged entirely in the interior.

The embodiment of the snap trap according to the invention also allows particularly straightforward assembly since, during assembly, basically all that is required is for the striking device to be inserted in the striking region of the housing in order for the trap to be brought into the ready-for-operation state. There is no need to fit any further housing parts or other components for protecting the housing or for closing off the housing on the end side.

The housing and various components of the striking device are preferably produced straightforwardly as moldings, e.g. using a plastics material, preferably by injection molding. It is possible in this case for the snap trap to be cleaned, if required, in a particularly straightforward manner, since it can be washed without this having any adverse effect on the functionality. Of course, other materials, for example wood, are also conceivable.

It goes without saying that the snap trap may advantageously also have, for the entry opening, a closing device which can be triggered by a small animal being present in the interior and by means of which the entry opening can be closed. This has the advantage that, when the closing device has been triggered, it is no longer possible for the animal, once entered into the interior of the trap, to pass out of the same again. For this purpose, the closing device can be triggered, preferably independently of the striking device, via a triggering element, for example a treading platform. It is also, of course, conceivable, however, for the closing device to be triggerable together with the striking device, in which case it also prevents contact, from the entry opening, with a small animal, or animal's body, arrested in the trap.

The striking device advantageously has one or more wall portions which, in the striking position, close the interior on the end side, wherein in particular the wall portion or portions, in the striking position, is or are arranged in and/or on the end-side opening of the interior. In particular, a wall portion is formed on the striking lever. Since the existing components of the striking device have wall portions which also serve for closing off the interior on the end side, these components perform a double function and allow a particularly straightforward design of the snap trap with only a small number of parts. It is also possible for the wall portions, as robust design elements of the relevant components, to ensure a high level of stability for these components.

In a preferred embodiment, the striking lever is mounted on the housing such that it can be pivoted about a geometrical pivoting axis arranged transversely to the longitudinal direction and parallel to the floor of the housing. It is preferable for the pivoting axis to be arranged, in a region which is in the vicinity of the floor, at that longitudinal end of the interior which is remote from the entry opening, i.e. at the striking-device longitudinal end in the striking region. The striking lever is thus arranged on the end side in relation to the interior and can be pivoted straightforwardly by a user on account of the pivoting axis being arranged in the vicinity of the floor.

It is preferable here for the striking lever to be swung outward away from the interior, counter to the spring force of the striking-spring element, as it transfers from the striking position into the standby position. The striking-spring element may be designed here, in a straightforward manner, in the form of a leg spring. The leg spring here comprises preferably two coils which are connected to one another via a bracket.

From each of the coils, one leg extends along a side wall of the housing for support on the housing. The bracket is supported on the striking lever, in which case the bracket is subjected to a spring force, in respect of the housing, via the coil. The leg spring may likewise be arranged in the interior of the housing and therefore, according to the invention, is protected, at least in the striking position, against access from the outside. The striking lever preferably has accommodating spaces for the coils of the leg spring, it being possible for the coils of the spring to be inserted into the accommodating spaces without an axial element having to be present for retaining purposes. It goes without saying that, depending on the particular use, spring elements of some other design may also be advantageous.

The striking lever is subjected to the spring force such that, when the snap trap is triggered, the striking lever is pivoted in the direction of the interior and into the same, wherein a striking element which is directed toward the interior, e.g. a striking plate with a striking bar for killing the animal, may be provided on the striking lever.

It goes without saying that any conceivable bearings or articulations which define the geometrical pivoting axis of the striking lever may be designed in various known ways. In the present case, preferably laterally outwardly projecting articulation protruberances are formed on the striking lever, these being mounted such that they can be pivoted in corresponding articulation sockets in the housing.

The striking lever advantageously has a striking plate with a striking bar which projects into the interior in the striking position and, in a region which is remote from the pivoting axis, adjoins the striking lever essentially in the perpendicular direction. The striking bar is provided here to deliver a fatal blow to the animal, in a narrow and defined region, when the striking device is triggered. In the striking position, the striking plate is arranged entirely in the interior and is protected against access from the outside by the housing-terminating means formed by the striking device. The striking bar is oriented preferably parallel to the pivoting axis.

The striking plate is designed preferably as a curved surface with a constant lateral distance from the pivoting axis of the striking lever. This ensures that a free space which is necessary for unobstructed pivoting of the striking lever, on account of the constant distance of the striking plate from the pivoting axis, can be selected to be minimal without a gap arising, during pivoting, between the striking plate and radially directly adjacent components.

For straightforward handling, the striking lever preferably has an actuating extension arm, by means of which the striking lever can be pivoted outward away from the interior, counter to the force of the striking-spring element, from the outside in the manner of the trigger, in order to bring the striking device out of the striking position into the standby position.

This results in particularly straightforward handling of the snap trap, which can be tensioned in the manner of a firearm trigger, for example, using the thumb. The actuation extension arm here may advantageously have an arrangement of grooves, in order to prevent slipping.

It is advantageously also the case that the triggering lever is mounted on the housing such that it can be pivoted about a geometrical pivoting axis arranged transversely to the longitudinal direction and parallel to the floor of the housing, wherein in particular the pivoting axis of the triggering lever is mounted in front of the pivoting axis of the striking lever, in the direction of the entry opening, as seen in the longitudinal direction. The triggering lever thus extends longitudinally further into the interior, and in the direction of the entry opening, than the striking lever. As in the case of the striking lever, it goes without saying that the bearings which define the geometrical pivoting axis may be designed in different ways. It is preferably also the case that laterally outwardly projecting articulation protruberances are formed on the triggering lever, these being mounted such that they can be pivoted in corresponding articulation sockets in the housing.

The triggering lever advantageously has two lever arms which extend laterally, internally along side walls of the housing, away from the pivoting axis of the triggering lever, in particular in a direction from the entry opening toward the striking lever. Since the lever arms run along the side walls, the triggering lever may be mounted on either side of the housing without a through-passage in the interior being significantly impeded by the triggering lever. A small animal, once entered into the entry region of the interior, can thus advance, without obstruction, to the striking lever and thus into a striking region of the striking device.

It goes without saying that it is also possible, in principle, for the triggering lever to have just one lever arm, although, for stability-related reasons, the embodiment with two lever arms and mounting on either side is preferred. It is advantageously possible for the lever arms to continue, via the region of the pivoting axis, into rocker arms, which are preferably arranged largely opposite the lever arms, in which case the triggering lever can be, for example, actuated, or subjected to a spring force, via the rocker arms.

It is preferable for those ends of the lever arms of the triggering lever which are remote from the pivoting axis to have formed on them a treading platform which extends transversely through the interior, in the vicinity of the floor. The treading platform is arranged in particular in a region which is further away from the entry opening, as seen in the longitudinal direction, than a region in which the striking bar of the striking lever is arranged in the striking position. This ensures that a small animal triggers the striking device only when it is located in the desired position for the fatal blow to be delivered.

It is preferable for a carrier for bait to be formed beneath the treading platform. The carrier here can be pushed into a corresponding aperture in the housing preferably transversely to the longitudinal direction, in which case it can be straightforwardly introduced into the interior, and/or exchanged, from the outside. The bait can thus be used independently of the triggering device and merely as a lure. It is preferable for the carrier, in the striking position, to be closed by the treading platform of the triggering lever, in which case the bait remains fresh when the trap is not in use. In the standby position, the tread platform may be raised, in which case the bait can exude, for example, a luring scent.

In the region of the treading platform, the triggering lever, when pivoted about its pivoting axis, is advantageously guided in a curved guide on the housing via laterally arranged guide protruberances. This ensures well-defined guidance of the triggering lever in the region which is provided for the triggering lever to be actuated by the animal. On the one hand, this can achieve secure and reliable triggering, whereas, on the other hand, a pivoting region of the triggering lever can be limited via appropriately provided stops of the curved guide.

The striking device advantageously comprises a blocking lever which, in the standby position, can be arrested in a releasable manner on the triggering lever and on which the striking lever can be arrested in a releasable manner in the standby position. It is, indeed, also conceivable, in principle, to have striking devices which have a triggering lever on which the striking lever can be latched directly. The additional blocking lever, however, means that the force which is necessary for triggering purposes may be reduced to a considerable extent. A striking-spring-element force may thus be comparatively large, while it is also still possible for the striking device to be triggered by very lightweight animals.

The blocking lever of the striking device is preferably mounted on the housing such that it can be pivoted about a geometrical pivoting axis arranged transversely to the longitudinal direction and parallel to the floor of the housing. The pivoting axis here is advantageously arranged, in a region which is remote from the floor, at that longitudinal end of the interior which is remote from the entry opening. This means that the striking lever, on account of its pivoting axis being arranged in the vicinity of the floor, and the blocking lever are arranged in optimal fashion in relation to one another in order to be able to interact with one another. It is preferable here for the pivoting axis to be arranged between the pivoting axes of the striking lever and of the triggering lever, as seen in the longitudinal direction. This arrangement allows the blocking lever to interact optimally with the striking lever and triggering lever.

As in the case of the striking lever or of the triggering lever, it goes without saying that the bearings which define the geometrical pivoting axis can be designed in different ways. Laterally outwardly projecting articulation protruberances are preferably formed, and these are mounted such that they can be pivoted in corresponding articulation sockets in the housing.

It is preferable for a respective wall portion to be formed both on the striking lever and on the blocking lever, which wall portions, at least in the striking position, together form a preferably complete end-side terminating means for the interior. The wall portions on the striking lever and on the blocking lever here strike preferably flush against one another and merge largely flush into the outer wall of the housing, in which case a largely step-free outer side is achieved in this region in the striking position. It is preferable here for the wall portion of the striking lever to cover over a significant part of the opening, whereas a smaller-surface-area wall portion of the blocking lever covers over a region which is left free by the wall portion of the striking lever. It goes without saying that, in variants, the terminating means may be provided by just one wall portion, e.g. by a wall portion on the striking lever or on the blocking lever alone. In particular, the wall portion or portions may also be formed on other components of the striking device.

In a preferred embodiment, the blocking lever has two lever arms which extend laterally, internally along side walls of the housing, from the pivoting axis of the blocking lever in the direction of the triggering lever. In a manner analogous to the triggering lever, this makes it possible, despite mounting on either side of the housing, to keep a through-passage free, in which case the animal can advance, without obstruction, to the striking lever and thus into the striking region of the striking device.

In variants which may be preferred, it is also possible for the blocking lever to have just one lever arm.

However, an embodiment with two lever arms provides for better mounting of the lever on the housing (on either side of the latter).

Those ends of the lever arms of the blocking lever which are remote from the pivoting axis have formed on them a respective latching edge, by means of which the blocking lever can be latched in a releasable manner on corresponding latching protrusions of the triggering lever. It is preferable here for the latching protrusions to be formed on the lever arms of the triggering lever. If the triggering lever is actuated, i.e. pivoted about its pivoting axis by a small animal stepping on the treading platform, the engagement of the latching edges with the latching protrusions can be released, as a result of which the blocking lever is freed and, for its part, can free the striking lever in turn.

In order to arrest the striking lever in the standby position, the blocking lever advantageously has a latching notch, it being possible for the striking lever, in particular the striking bar of the striking lever, to be latched in said latching notch in the standby position. The latching notch here is formed preferably in a region of the blocking lever in the vicinity of the pivoting axis thereof. If the blocking lever, as described above, has two lever arms, a respective latching notch is formed preferably on each lever arm.

Since, in contrast, the latching edge of the blocking lever, for latching on the triggering lever, is formed preferably at those longitudinal ends of the lever arms which are remote from the pivoting axis, the resulting leverages mean that there is only a small spring force present at the latching edge of the blocking lever when the striking lever, subjected to a comparatively large spring force, is arrested in the latching notch of the blocking lever.

The blocking lever preferably has a rocker arm which, advantageously in relation to the associated pivoting axis, is arranged largely opposite the lever arms and is oriented such that, when a standby position is reached, the blocking lever is pivoted by the striking lever, via the rocker arm, such that the latching notch grips the striking bar. The rocker arm is preferably arranged such that the striking bar of the striking lever, when the standby position is reached, strikes against the stop and thus pivots the blocking lever. It goes without saying that it is also possible to provide other, albeit usually more complex, means such as, for example, stops or control curves to allow the blocking lever to be pivoted by the striking lever.

It is preferable to have present a blocking-spring element, by means of which the triggering lever can be pre-tensioned against the blocking lever during transfer from the striking position into the standby position. The blocking-spring element here is formed preferably in one piece with the blocking lever, in particular as a spring tongue. The blocking-spring element advantageously extends, largely in the direction of the lever arms of the blocking lever, toward the triggering lever. In particular it is possible for the blocking-spring element, as it transfers from the striking position into the standby position, to act on the triggering lever such that the latter can be forced by a spring force, in the region of its latching edges, against the latching edges of the blocking lever. For this purpose, the blocking-spring element can preferably interact with the aforementioned rocker arms of the triggering lever such that, on account of the spring force, the lever arms are raised away from the floor and pivoted in the direction of the lever arms of the blocking lever. It is also possible here for the treading platform of the triggering lever, said platform connecting the lever arms, to be raised away from the floor of the entry space as it transfers into the standby position. In the striking position, and in particular also in the standby position, the spring tongues subject the rocker arms to only a small amount of spring force, or preferably to none at all, in order to prevent the situation, in particular in the case of an embodiment made of plastics material, where the spring force of the spring tongues decreases over time on account of shape-memory effects or plastic deformation of the spring material on account of constant loading.

It goes without saying that, in all the embodiments, the interior of the snap trap is adapted preferably to the respective use and to the animal such that the animal is accommodated largely entirely in the interior when it is able to trigger, or triggers, the striking device. Depending on whether the trap is provided for example for rats or mice, the interior and the striking device may be dimensioned correspondingly. It is not imperative here for example also for the animal's tail to be accommodated entirely in the interior. The entry region of the snap trap is thus advantageously at least double the length of the striking region.

It is particularly preferable for the striking-spring element to be designed in the form of a leg spring and symmetrically in relation to a longitudinal center plane perpendicular to the floor of a housing, i.e. a plane which stands vertically on the housing floor and comprises the longitudinal axis. The leg spring comprises two spring coils which are connected via a bracket and are arranged in associated accommodating spaces of the striking lever. The coils here are arranged on the striking lever in each case in the vicinity of a housing side wall on either side of the striking lever. The axes of the coils here are arranged coaxially in relation to the pivoting axis of the striking lever. It is particularly advantageous for the coils in the accommodating spaces to be at least partially encased on the outside by walls of the accommodating spaces so as to ensure that the coils are retained in a pin-free manner. Retained in a pin-free manner here refers to the coils being retained in such a manner that the respective coil is not positioned on an axial element or a pin. The bracket the coil-connecting bracket is supported on the striking lever, whereas a respective leg, extending from each of the coils, of the leg spring is supported on the housing. The leg spring thus allows uniform and constructionally straightforward spring activation of the striking lever, in relation to its pivoting axis, in respect of the housing.

Further individual features and advantages of the invention can be gathered from the following description of the exemplary embodiments and the associated drawings, in which, schematically:

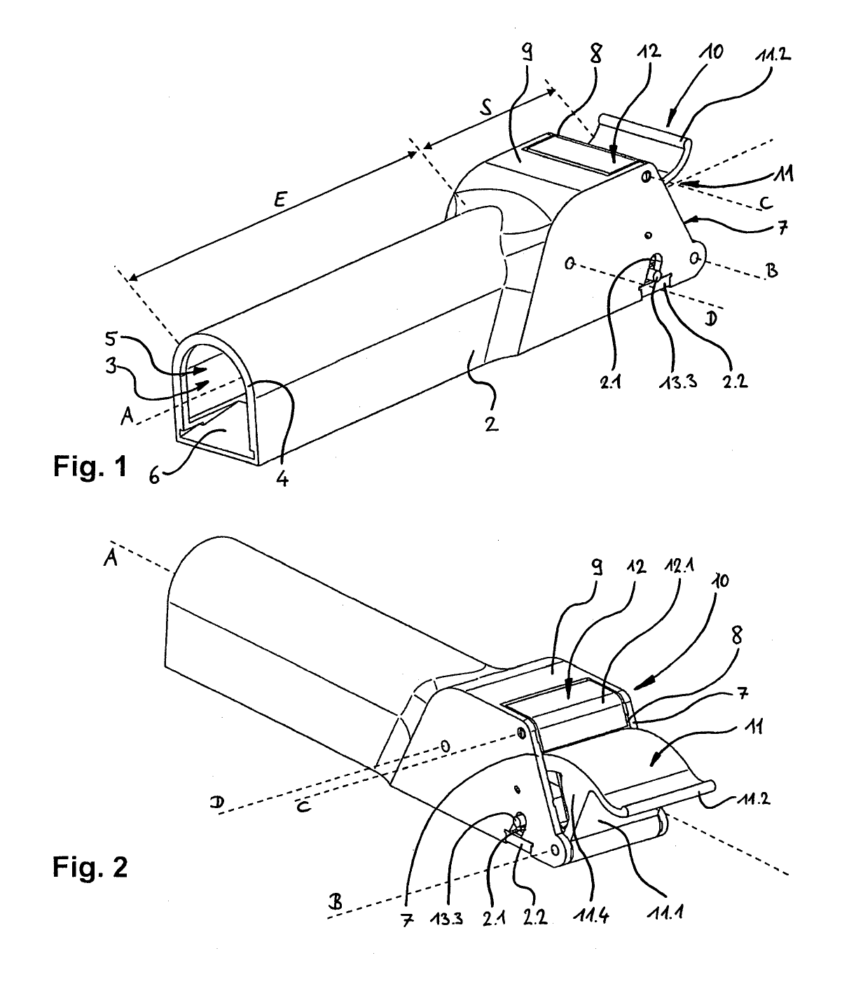

FIG. 1 shows an oblique view of the outside of a snap trap according to the invention in the striking position;

FIG. 2 shows an oblique view of the outside of the snap trap according to FIG. 1 in the standby position;

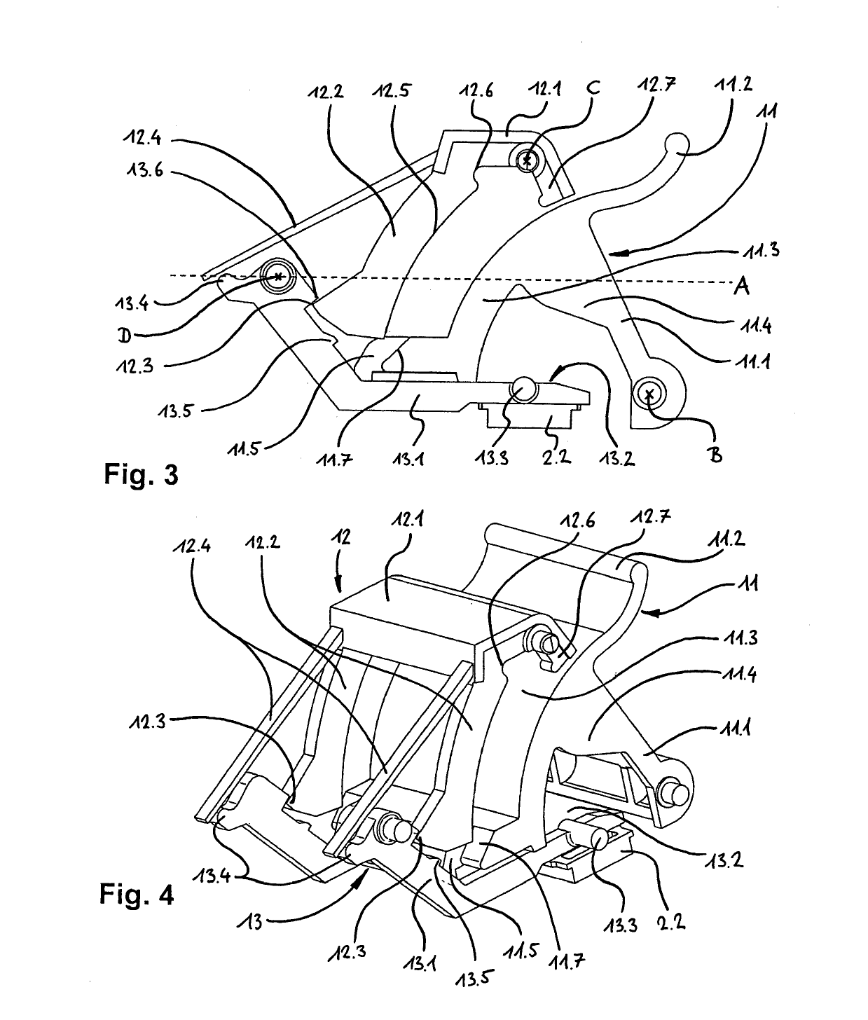

FIG. 3 shows a side elevation of the striking device of the snap trap in the position according to FIG. 1;

FIG. 4 shows an oblique view of the outside of the striking device of the snap trap in the position according to FIG. 3;

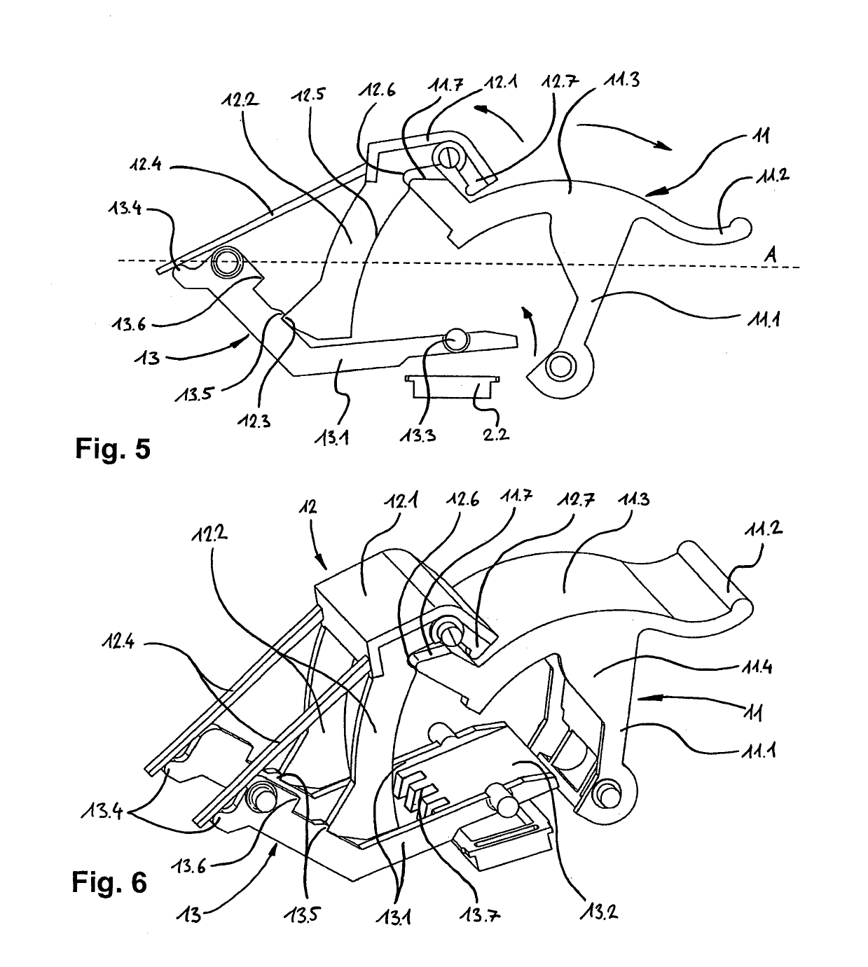

FIG. 5 shows a side elevation of the striking device of the snap trap in the position according to FIG. 2;

FIG. 6 shows an oblique view of the outside of the striking device of the snap trap in the position according to FIG. 5; and

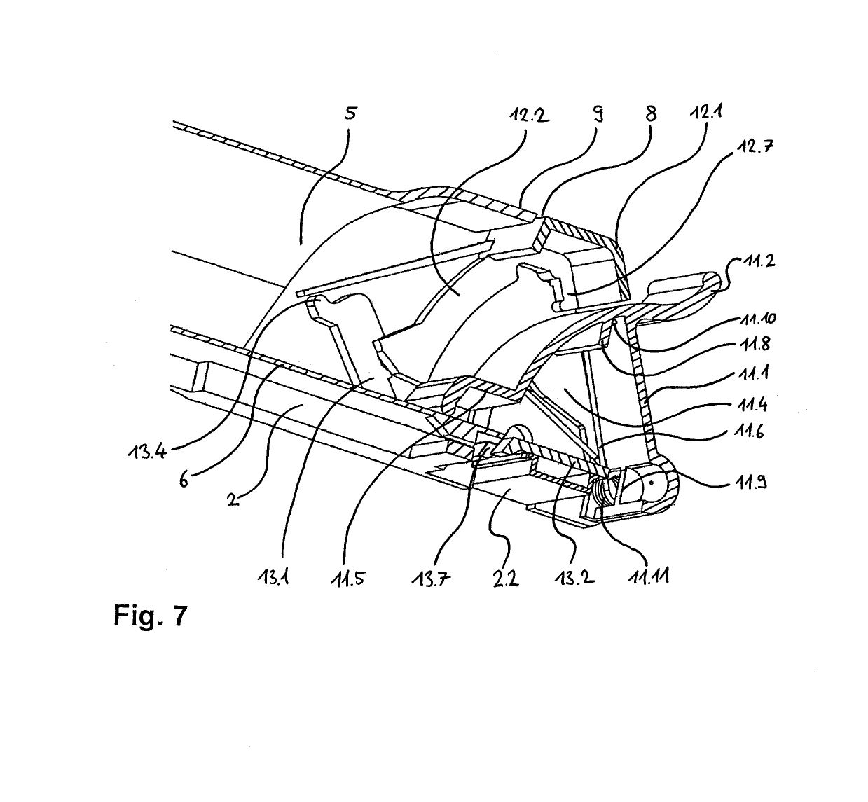

FIG. 7 shows a longitudinal section through the snap trap according to FIG. 1 in the region of the striking device.

In principle, like elements are provided with like designations in the figures.

FIG. 1 shows an oblique view of a snap trap 1 according to the invention from the outside, as seen in the direction of an entry opening 3 in a housing 2.

The housing 2 has a tubular entry portion E, on which the entry opening 3 is formed on an end side 4, which will be referred to hereinbelow using the expressions “front side” or “forward”. A striking portion S of the housing 2, in which a striking device 10 is arranged, follows in a longitudinal direction A of the tubular entry portion E.

The entry portion E and the striking portion S, in the present case, are formed as a single-piece housing 2. Starting from the entry opening 3, an interior 5 passes all the way through the housing 2 in the longitudinal direction A. The interior 5 is of tunnel-like design in the entry portion E, whereas the interior 5 has an essentially rectangular cross section in the striking portion S. The housing 2 has an essentially planar floor 6 over its entire length. Hereinbelow, a direction taken largely perpendicularly to, and toward, the floor 6 will be referred to using the expressions “bottom” and “downward”, whereas, correspondingly, the opposite direction away from the floor 6 will be referred to using the expressions “upward” and “top”.

At a longitudinal end of the housing 2 which is located opposite the front end side 4, this longitudinal end being referred to hereinbelow as “rear” longitudinal end, the housing 2 has an end side 7 which is inclined obliquely in the forward direction in relation to the floor 6. A largely rectangular opening 8 of the interior 5 is formed on the end side 7 and, in the present case, continues on an upper side 9 of the housing 2 in the striking portion S.

In the illustration of FIG. 1, the striking device 10 is located in a striking position. In this position, a striking lever 11, which is mounted on the end side of the end surface 7 of the housing 2, in the vicinity of the floor, such that it can be pivoted about a transverse axis B, has been pivoted into the interior 5. The striking lever 11 is designed such that it has a wall portion 11.1 at least partially closing the opening 8 over its entire width (see, for this purpose, for example also FIG. 7). The wall portion 11.1 here is arranged in the opening 8 in a largely coplanar manner in relation to the end surface 7 and terminates flush with an adjacent periphery of the opening 8.

A blocking lever 12 is mounted on the end surface 7 of the housing 2, in the vicinity of the upper side 9, such that it can be pivoted about a pivoting axis C. The blocking lever 12 here has a wall portion 12.1, which is formed in the region of its pivoting axis C and by means of which a region of the opening 8 which is left free by the striking lever 11 is closed over its entire width. The wall portion 12.1 terminates largely flush with an adjacent peripheral portion of the opening 8 and with the wall portion 11.1 of the striking lever 11. The wall portion 12.1 here has a transversely oriented edge, in which case an edge-defined first region of the wall portion 12.1 closes the opening 8 on the upper side 9 and the other edge-defined region closes that region of the opening 8 on the end side 7 which is left free by the wall portion 11.1. The pivoting axis C of the blocking lever here is arranged directly on the wall portion, parallel to the edge. In the striking position, the striking lever 11 and blocking lever 12 thus together close the opening 8 and together form a complete end-side terminating means for the interior 5.

On a region of the wall portion 11.1 which is remote from the axis, the striking lever 11 has an actuating extension arm 11.2, which projects largely perpendicularly from the outside of the wall portion 11.1. Via the actuating extension arm 11.2, a user can straightforwardly pivot the striking lever 11 about its pivoting axis B.

FIG. 2 shows an oblique view of the snap trap 1 according to the invention from the outside, as seen in the direction of the rear end side 7, in a standby position. In this position, the striking lever 11 has been pivoted out to the rear by a predetermined angle about its pivoting axis B and has been arrested in this position (see, for this purpose, also FIGS. 5 and 6). In the pivoted-out position, it is possible to see, from the outside, a striking plate 11.3 of the striking lever 11, said striking plate extending into the interior 5 and, in a region which is remote from the axis, adjoining the wall portion 11.1 largely perpendicularly to the wall portion 11.1.

The striking plate 11.3 is designed to be curved, as part of a lateral surface of an imaginary circular cylinder arranged coaxially with the pivoting axis C. It is thus possible for the striking lever 11 to be pivoted out of that region of the opening 8 which is left free by the wall portion 12.1 of the blocking lever 12, without there being any change in the radial distance, as seen in relation to C, between the striking plate 11.3 and the wall portion 12.1. This means that a largely complete closure of the opening 8 is also ensured when the striking lever 11 is being pivoted out. In addition, side walls 11.4 are formed between the striking plate 11.3 and wall portion 11.1, in which case, even when the striking lever 11 has been pivoted out, a lateral access to the opening 8, this access being created by the pivoted-out striking lever 11, is largely closed off.

The function of the striking device 1 will be described in more detail hereinbelow with reference to FIGS. 3 to 6.

FIG. 3 shows a side elevation of the striking device in the striking position, an illustration of the housing 2 having been dispensed with for the sake of clarity. FIG. 4 shows an oblique view of the outside of the striking device 10 in the same position. FIGS. 3 and 4 will be described together hereinbelow.

The striking lever 11 has been pivoted all the way forward about its pivoting axis B, in which case the striking plate 11.3 has been lowered, by way of a striking bar 11.5, onto two lever arms 13.1 (see also FIG. 5) of a triggering lever 13. The triggering lever 13 here is mounted on the housing 2 in front of the striking lever 11, as seen in the longitudinal direction A, such that it can be pivoted about a pivoting axis D arranged transversely to the longitudinal direction A. Starting from the pivoting axis D, the lever arms 13.1 extend rearward in the direction of the striking lever 11 and end in a region behind the striking bar 11.5. The triggering lever 13 also has short rocker arms 13.4, which, in relation to the pivoting axis D, are arranged in a rocker-like manner largely opposite the lever arms 13.1. In each case one of the lever arms 13.1 here is arranged in the vicinity of an inner side of a side wall of the housing 2, in which case it is possible to pass through a central region of the interior 5 essentially without obstruction.

At free longitudinal ends, the lever arms 13.1 are connected to one another via a treading platform 13.2, which extends transversely through the interior 5 (see, for example, FIGS. 4 and 6). In the region of the treading platform 13.2, outer guide protruberances 13.3 are formed on either side of the lever arms 13.1, these protruberances engaging in curved guide grooves 2.1 of the housing 2. The guide grooves 2.1 guide the pivoting movement of the triggering lever 13 and, at the same time, limit the pivoting region thereof.

A carrier 2.2 for bait is illustrated beneath the treading platform 13.2. The carrier 2.2 is of tray like design for accommodating the bait and is open in the upward direction. In the striking position, the treading platform 13.2 is already lowered onto the carrier 2.2 and closes the same. The carrier 2.2 is designed such that it can be pushed preferably transversely into a corresponding recess in the housing 2, preferably in the floor 6, in which case the bait can be, for example, renewed in a straightforward manner. Since, in the striking position, the striking lever 11, subjected to the force of a spring 11.6, rests on the lever arms 13.1, and pushes the same against the carrier 2.2, the triggering lever 13 and the treading platform 13.2 are fully secured in the striking position.

The blocking lever 12 likewise has two lever arms 12.2 which extend in the vicinity of an inner side of the side wall of the housing 2, from the pivoting axis C in the direction of the triggering lever 13. The lever arms 13.1 of the triggering lever 13 and the lever arms 12.2 of the blocking lever 12 here are arranged in the same longitudinal plane oriented largely parallel to the side wall of the housing 2. On the blocking-lever side, the lever arms 12.2 have a concavely circular profile 12.5, which allows the blocking lever 11 to pivot freely without the blocking lever 12 having to be pivoted out of the position which it assumes in striking position. At a pivoting-axis end of the profile 12.5, the latter merges into a latching notch 12.6, which is provided for the latching of the striking bar 11.5 in the standby position. A rocker arm 12.7 is formed in a rocker-like manner, largely opposite the lever arms 12.2, in the region of the pivoting axis C, and the striking bar 11.5, when it reaches the standby position, strikes against the same and pivots the blocking lever 12, by way of its levers 12.2, rearward for arresting purposes (see FIG. 4). In the present case, the rocker arm 12.7 is formed by part of the wall portion 12.1.

From a region of the blocking lever 12 at the pivoting axis C, spring tongues 12.4, which are connected rigidly to the blocking lever 12, extend above the lever arms 12.2 in the direction of the rocker arms 13.4 of the triggering lever 13. The spring tongues 12.4 here are arranged just above the rocker arms 13.4, in the same longitudinal plane as the lever arms 12.2 and 13.1, and, in the striking position, subject the rocker arms 13.4 to only a small amount of spring force, or none at all.

Latching protrusions 13.5 are formed on the blocking-lever side of the lever arms 13.1 of the triggering lever 13, it being possible for latching edges 12.3 formed on the end sides of the lever arms 12.2 of the blocking lever 12 to latch on said latching protrusions. In the striking position, the latching edges 12.3 of the blocking lever 12 butt against a latching stop 13.6 of the lever arms 13.1, this latching stop being formed closer to the pivoting axis D than the latching protrusions 13.5. The blocking lever 12 is thus secured on the triggering lever 13 in a resilient manner, in the striking position, via the spring tongues 12.4 and the latching stop 13.6, the latching edges 12.3 of the blocking lever being arranged in a longitudinal region in front of the latching protrusions 13.5.

FIG. 5 shows the striking device 10 in the standby position, in which the striking lever 11 has been tensioned and arrested by the triggering lever 13 via the blocking lever 12. FIG. 6 shows an oblique view of the outside of the striking device 1 in the same position. FIGS. 5 and 6 will be described together hereinbelow.

In order to bring the striking device 10 out of the striking position into the standby position, the striking lever 11 is subjected to a setting force, and pivoted rearward out of the interior 5 (see arrow, FIG. 5), by a user, for example via the actuating extension arms 11.2. A leg spring 11.6 forces the striking lever 11, counter to the pivoting-out movement, in the direction of the interior 5 (see FIG. 7).

When the striking lever 11 is being pivoted out in the rearward direction, the blocking lever 12 and triggering lever 13 remain essentially at rest, that is to say they are in essentially the same position as in the striking position, until just before the standby position is reached. If the striking bar 11.5 strikes against the rocker arm 12.7 from the bottom, the blocking lever 12 is pivoted rearward by way of its lever arms 12.2. The striking bar 11.5 here passes into the latching notch 12.6 of the blocking lever 12 by way of appropriately formed latching regions 11.7. In addition, the spring tongues 12.4, which have been pivoted downward by way of the lever arms 12.2, subject the rocker arms 13.4 of the triggering lever 13 to a force from the top, in which case the lever arms 13.1 of the triggering lever are pivoted upward about the pivoting axis D in the manner of a rocker. On the one hand, here, the treading platform 13.2 is raised up from the carrier 2.2 and frees the bait. On the other hand, the latching edges 12.3 of the blocking lever 12 pass behind the latching protrusions 13.5 of the triggering lever 13. On account of the triggering lever 13 being subjected to the spring force of the spring tongues 12.4, the latching protrusions 13.5 here are raised here into a position in front of the latching edges 12.3 of the blocking lever 12. Pivoting of the triggering lever 13 in the upward direction, i.e. away from the floor 6, by way of its lever arms 13.1 is limited here by virtue of the guide protruberances 13.3 engaging in the guide grooves 2.1 of the housing 2.

If the striking lever 11 is relieved of the setting force applied by the user, the force of the spring 11.6 pushes the striking lever 11 in the direction of the interior 5. The striking lever 11 subjects the blocking lever 12 here, via the latching notch 12.6, to a force which pushes the lever arms 12.2 forward and, by way of their end-side latching edges 12.3, against the latching protrusions 13.5. The blocking lever 12 and striking lever 11 are thus secured on the triggering lever 13 via the latching. This gives rise to a lever system, made up of the striking lever 11, blocking lever 12 and triggering lever 13, which is subjected to static pre-tensioning by the spring 11.6.

If, then, a small animal passes into the snap trap 1 and steps on the treading platform 13.2, the triggering lever 13 is pivoted downward by way of its lever arms 13.1. This releases the engagement between the latching edge 12.3 and the latching protrusions 13.5, as a result of which the blocking lever 12 can pivot out in the forward direction by way of its lever arms 12.2. The striking bar 11.5 here slides out of the latching notch 12.6 and, accelerated by the force of the spring 11.6, can freely deliver a blow to the animal. If there is no animal in the trap, the striking movement of the striking lever 11 is stopped by the impact of the striking bar 11.5 on the lever arms 13.1 of the triggering lever 13. The lever arms 13.1 here are pushed downward in the direction of the floor 6, wherein the treading platform 13.2 is lowered onto the carrier 2.2 again and closes the same.

FIG. 7 shows a longitudinal section in a longitudinal plane through the snap trap 1 in the striking position, in the region of the striking device 10.

In particular the arrangement of in each case one of the lever arms 12.2 and 13.2 and of one of the spring tongues 12.4 in a common longitudinal plane in the vicinity of the side wall in striking region S of the housing 2. It is immediately clear from FIG. 7 that these components barely obstruct the interior 5 in any way, in which case the animal can pass through the interior, up to the striking lever 11, largely freely.

It can likewise be seen that the leg spring 11.6 has one of its legs supported in a recess on the housing 2. A further leg, designed in the form of a bracket 11.10, is supported on a supporting crosspiece 11.8 arranged on the inside of the striking plate 11.3. A coil 11.11 of the leg spring 11.6 here is arranged in an accommodating space 11.9 of the striking lever 11, largely coaxially with the pivoting axis B. In the accommodating space 11.9, the coil 11.11 is partially encased from the outside so as to ensure that the spring 11.6 is retained in a pin-free manner without any axial element being required. The bracket 11.10 here extends, from one side of the housing to the other, to a further coil (not illustrated), in which case a respective coil is arranged at a side wall of the housing 2, each in an accommodating space of the striking lever 11. A further leg (not illustrated), extending from the further coil, is supported on the opposite housing wall. The leg spring 11.6 is of mirror-symmetrical design in relation to the plane B.

It is likewise possible to see the opening 8 being closed according to the invention by the wall portions 11.1 and 12.1 of the striking lever 11 and of the blocking lever 12, respectively. As is likewise evident from FIG. 7, the floor 6 is formed in the housing 2 such that the treading platform 13.2 of the triggering lever 13, in the lowered state, terminates largely flush with the floor 6. This has the advantage that, in the standby position, the treading platform 13.2 projects only to a slight extent above the floor 6. The carrier 2.2 here is arranged some way beneath a floor plane and has been pushed into the housing 2, in a corresponding guide, from the side. The treading platform 13.2 also has ventilating slots 13.7, which ensure that a luring scent exuded by the bait is better propagated into the interior 5.

1. A snap trap for small animals, such as mice or rats, having a striking device, which can be brought into a striking position and a standby position, comprising a housing with a floor and an elongate interior, which is open at the two longitudinal ends and has an entry opening to an, in particular tunnel-like, entry portion of the housing arranged at its one longitudinal end and has the striking device arranged at its other longitudinal end, in a striking region of the housing, wherein the striking device comprises a striking lever and a triggering lever, and the striking lever can be pre-tensioned counter to the spring force of a striking-spring element as it transfers from the striking position into the standby position, wherein the striking lever can be arrested in the standby position such that it can be released directly or indirectly by the triggering lever, and the triggering lever is arranged such that the arresting of the striking lever can be released via the triggering lever by a small animal being present in the interior,
wherein
the striking device is designed for at least partially closing an end-side opening of the interior in the striking region of the housing, in particular it completely closes the opening when the striking device is in the striking position.

2. The snap trap as claimed in claim 1, wherein the striking device has one or more wall portions which, in the striking position, close the end-side opening of the interior, wherein in particular the wall portion or portions, in the striking position, is or are arranged in and/or on the end-side opening of the interior, wherein a wall portion is formed in particular on the striking lever.

3. The snap trap as claimed in claim 1, wherein the striking lever is mounted on the housing such that it can be pivoted about a geometrical pivoting axis arranged transversely to the longitudinal direction and parallel to the floor of the housing, wherein the pivoting axis, in particular in a region which is in a vicinity of the floor, is arranged at that longitudinal end of the interior which is remote from the entry opening.

4. The snap trap as claimed in claim 3, wherein the striking lever has a striking plate with a striking bar which projects into the interior and, in a region which is remote from the pivoting axis, adjoins the striking lever essentially in the perpendicular direction, wherein the striking plate is designed preferably as a curved surface with a constant lateral distance from the pivoting axis of the striking lever.

5. The snap trap as claimed in claim 3, wherein the striking lever has an actuating extension arm, by means of which the striking lever can be pivoted outward away from the interior, counter to the force of the striking-spring element, from the outside in the manner of a trigger, in order to bring the striking device out of the striking position into the standby position.

6. The snap trap as claimed in claim 1, wherein the triggering lever is mounted on the housing such that it can be pivoted about a geometrical pivoting axis arranged transversely to the longitudinal direction and parallel to the floor of the housing, wherein in particular the pivoting axis of the triggering lever is mounted in front of the pivoting axis of the striking lever, in the direction of the entry opening, as seen in the longitudinal direction.

7. The snap trap as claimed in claim 6, wherein the triggering lever has two lever arms which extend laterally, internally along side walls of the housing, away from the pivoting axis of the triggering lever, in particular in a direction from the entry opening toward the striking lever.

8. The snap trap as claimed in claim 7, wherein those ends of the lever arms of the triggering lever which are remote from the pivoting axis have formed on them a treading platform which extends transversely through the interior, in the vicinity of the floor, and is arranged in particular in a region which is further away from the entry opening, as seen in the longitudinal direction, than a region in which the striking bar of the striking lever is arranged in the striking position.

9. The snap trap as claimed in claim 8, wherein, in the region of the treading platform, the triggering lever, when pivoted about its pivoting axis, is guided in a curved guide on the housing via laterally arranged guide protruberances.

10. The snap trap as claimed in claim 1, wherein the striking device comprises a blocking lever which, in the standby position, can be arrested in a releasable manner on the triggering lever and on which the striking lever can be arrested in a releasable manner in the standby position.

11. The snap trap as claimed in claim 10, wherein the blocking lever is mounted on the housing such that it can be pivoted about a geometrical pivoting axis arranged transversely to the longitudinal direction of the housing and parallel to the floor, wherein the pivoting axis is arranged, in particular in a region which is remote from the floor, at that longitudinal end of the interior which is remote from the entry opening, wherein preferably the pivoting axis is arranged between the pivoting axes of the striking lever and of the triggering lever, as seen in the longitudinal direction.

12. The snap trap as claimed in claim 10, wherein a respective wall portion is formed on the striking lever and on the blocking lever, which wall portions, in the striking position, together form a preferably complete end-side terminating means for the interior.

13. The snap trap as claimed in claim 12, wherein the blocking lever has two lever arms which extend laterally, internally along side walls of the housing, from the pivoting axis of the blocking lever in the direction of the triggering lever, wherein those ends of the lever arms of the blocking lever which are remote from the pivoting axis have formed on them a respective latching edge, by means of which the blocking lever can be latched in a releasable manner on corresponding latching protrusions of the triggering lever, said latching protrusions being formed preferably on the lever arms of the triggering lever.

14. The snap trap as claimed in claim 10, wherein the blocking lever has a latching notch, in particular has a respective latching notch on each of its lever arms, it being possible for the striking lever, in particular the striking bar of the striking lever, to be latched in said latching notch in the standby position, wherein preferably the latching notch is formed in a region of the blocking lever in the vicinity of the pivoting axis thereof.

15. The snap trap as claimed in claim 14, wherein the blocking lever has a rocker arm which, preferably in relation to the associated pivoting axis, is arranged largely opposite the lever arms and is arranged such that, when the standby position is reached, the blocking lever is pivoted by the striking lever, via the rocker arm, such that the latching notch grips the striking bar.

16. The snap trap as claimed in claim 10, comprising a blocking-spring element, by means of which the triggering lever can be pre-tensioned against the blocking lever during transfer from the striking position into the standby position, wherein the blocking-spring element is formed preferably in one piece with the blocking lever, in particular as a spring tongue, and acts on the triggering lever in particular such that the latter can be forced by a spring force, in the region of its latching protrusions, against the latching edges of the blocking lever.

17. The snap trap as claimed in claim 1, wherein the entry region is at least double the length of the striking region.

18. The snap trap as claimed in claim 1, wherein the striking-spring element is designed in the form of a leg spring and symmetrically in relation to a longitudinal center plane perpendicular to the floor of the housing, wherein the leg spring has two coils which are connected via a bracket, are arranged in associated accommodating spaces of the striking lever, have a coil axis arranged coaxially in relation to the pivoting axis of the striking lever and are at least partially encased on the outside by walls of the accommodating spaces so as to ensure that the coils are retained in a pin-free manner, wherein the bracket is supported on the striking lever.
